(19) United States
(12) Patent Application Publication
(10) Pub. No.: US 2006/0144497 A1
(43) Pub. Date: Jul. 6, 2006

(54) Method for producing plasterboard with four tapered edges

(75) Inventor: Michel Capron, Hochstatt (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: LAFARGE PLATRES, AVIGNON CEDEX 9 (FR)

(21) Appl. No.: 10/513,038

(22) PCT Filed: May 2, 2003
(86) PCT No.: PCT/FR03/01373

§ 371 Date: Nov. 1, 2004

(30) Foreign Application Priority Data
May 2, 2002 (FR) 02 05 490

(51) Int. Cl. B28B 19/00

(52) U.S. Cl. 156/39; 156/348

(57) ABSTRACT

The invention relates to a method of producing plaster boards (12) in which two bound sheets of paper, namely one cream paper (3) and one grey paper (4), enclose a plaster-based hydraulic binder (2) in a former (7), thereby creating a composite strip (10) which hardens on two hardening strips (8 and 9), said strips having two horizontal tapering strips disposed along the edge thereof. The invention consists in: shaping the cream paper (3) along emboss lines (20); providing stiffening slots (23) on either side of the emboss lines (20); reinforcing the mechanical strength of said emboss lines (20) by covering same with a coating (15); allowing the emboss lines (20) to exceed the aforementioned former (7) and the hardening strips (8 and 9) and generating the double slope imprint (19); and, subsequently, cutting the composite strip (10) to the right and at the middle of each double slope imprint (19).

### BACKGROUND OF THE INVENTION

The present invention relates to a method and apparatus for producing plasterboard with four tapered edges at the outer edge of each board.

The invention is in the field of continuous plasterboard production in which two sheets of cardboard-type paper, the lower one of which, because of its color is called the cream or facing paper (hereinafter the facing paper) and the other upper one being called the gray or backing paper are unrolled and come to enclose a plaster-based hydraulic binder inside a shaping means in the form of shaping plates or shaping rollers.

These two sheets of paper constitute, with the hydraulic binder, a composite strip which generally hardens on two hardening belts at the edges of which two narrow taper reservation strips are present allowing the future board to be provided with longitudinal tapered edges.

This composite strip is cut to the desired length, passed through the drying oven and is finally recut to its definitive length before being stacked. Such a method is well-known and will not be described further in detail in this specification.

The value of having tapered edges all around plasterboard has been known and appreciated for many years. Indeed, they facilitate the abutment and jointing of plasterboard and allow large surface area constructions to be built with excellent flatness characteristics and mechanical strength.

For many years now, it is known how to produce plasterboard with tapered longitudinal edges on continuous manufacturing lines but there is no method allowing production, on such continuous operating lines, of plasterboard with transverse tapered edges having the same characteristics as the longitudinal tapered edges.

There have obviously been numerous attempts and numerous patents have been taken out, essentially U.S. patents, attempting to resolve this problem of continuous production of tapered transverse edges. U.S. Pat. No. 2,238,017 in particular attempted, in 1941, to create excess thickness by bending of cardboard but this invention never went into industrial development probably because the bending did not withstand the tension in the paper or the weight of the hydraulic binder.

It must be recognized that currently, plasterboard with tapered transverse edges if boards do exist are either the result of machining of the edges called tapering or feathering or artifices such as grooving, pressing and bonding of the edge, or, more frequently, are provided by the artisan who simply planes the edge of the board to provide a transverse taper.

These solutions are all expensive in terms of cost of producing the board and moreover the qualities of the transverse taper thus realized are far from those of the longitudinal taper. Today both the market and industry have really high expectations as regards this situation.

### SUMMARY OF THE INVENTION

The method and its apparatus according to the invention allow these disadvantages to be overcome.

A solution to the problem posed is according to the invention a production line of the type presented in the introduction, which consists of:

embossing the facing paper on-the-fly along the lines of protuberances transverse and perpendicular to the direction of unwinding of said facing paper.

reinforcing, on-the-fly, the mechanical strength of these protuberances along two notch lines arranged either side of the latter,

reinforcing, on-the-fly, the mechanical strength of these protuberances by means of a hardening coating, sprayed inside and around the latter,

repeating these lines of protuberances on the facing paper, at a precise step,

allowing these lines of protuberances projecting approximately 1.5 mm below the facing paper to cross the former and the hardening belts,

cutting the composite strip with the shears right in the middle of the imprint left by the line of protuberances during the embossing, and hardening of the composite band.

The result is a novel production method and apparatus which satisfactorily address the problem posed, the transverse tapers resulting from the imprints having surface appearance, shape and strength qualities identical to those of longitudinal tapers and being satisfactorily produced using a continuous method which proves to be very cheap and very attractive to the plaster board industry and market.

The description and FIGS. below represent an example of producing plaster-based board-bound plates showing the particular advantages of the invention as mentioned previously, but without being limiting: other production methods are possible within the scope and extent of the invention, in particular the production of plaster boards using mineral-based papers or glass mats instead of cardboard-type papers or more generally the production of plates using two sheets or an envelope enclosing, after passing into a former, a drying hydraulic binder.

### BRIEF DESCRIPTION OF THE DRAWINGS

FIG. 1 shows the head of the production line in which the novel method of the invention is used.

FIG. 1a shows, according to the invention, in side view and enlarged the line of protuberances just before it passes below the mixer.

FIG. 1b shows, according to the invention, in side view and enlarged the line of protuberances just after it has passed below the mixer and before it passes into the former.

FIG. 1c shows, according to the invention, in side view and enlarged the line of protuberances just after it has passed into the former and during its passage over the hardening belts.

FIG. 1d shows, according to the invention, in side view and enlarged the line of protuberances leaving the hardening belts and before the shear cut.

FIG. 1e shows according to the invention, in side view and enlarged the line of protuberances just after the shear cut.

FIG. 2 shows a plaster board with 4 tapered edges that has been produced with the method of the invention.

FIG. 3 shows the apparatus according to the invention for berthing the facing paper and realizing the lines of protuberances.

FIG. 4 shows the view along F of the apparatus of FIG. 3.

FIG. 5 shows, according to the invention, the facing paper seen from below, as machined after it has crossed the apparatus of FIGS. 3 and 4.

FIG. 6 shows, according to the invention, the section and perspective view SS′RR′ of the facing paper of FIG. 5.

FIG. 7 shows, according to the invention, the side and section view of the facing paper at the line of protuberances before it passes below the mixer.

FIG. 8 shows, according to the invention, the side and section view of the composite strip at the line of protuberances after it has passed into the former.

FIGS. 9 and 10 show, according to the invention, the side and section view of the composite strip at the line of protuberances immediately after the cutting operation.

### DETAILED DESCRIPTION OF PREFERRED EMBODIMENTS

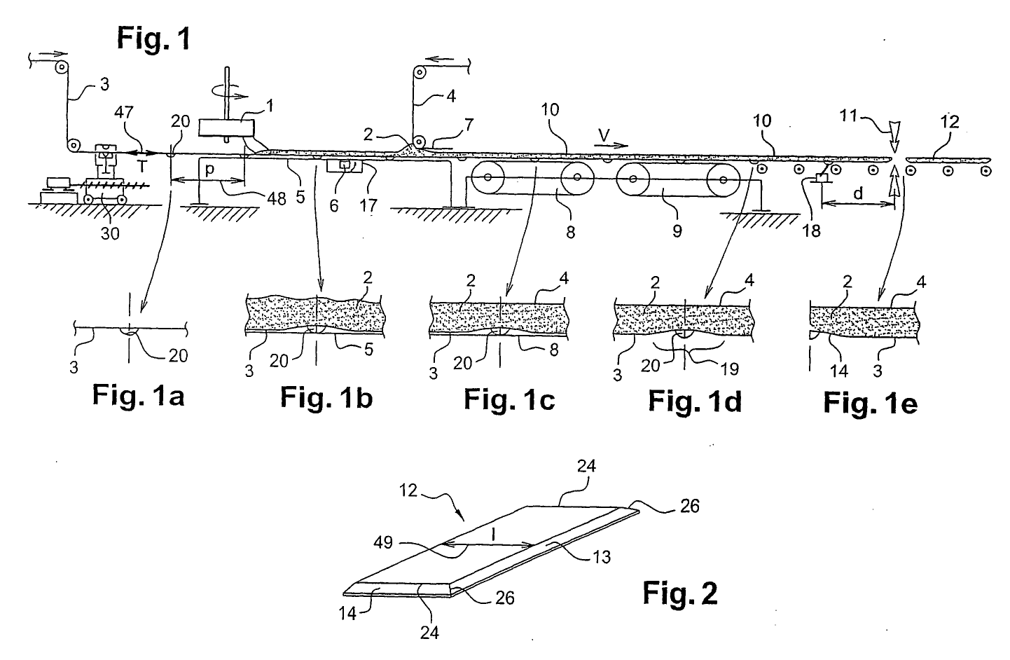

FIG. 1 shows a continuous production line for plaster board (12), of the type described in the introduction, in which two sheets of cardboard-type paper, a lower one constituting facing paper (3) and an upper gray or backing paper (4), unwind and enclose in a former (7) a hydraulic binder (2) coming from a mixer (1). These two sheets of cardboard-type paper, cream (3) and gray (4) constitute with the hydraulic binder (2) a composite strip (10) which hardens on the two hardening belts (8) and (9). These two hardening belts (8) and (9) have at their edges two small tapered strips which will create the longitudinal tapers (13) on the composite strip (10). The composite strip (10) is cut to length l by the shears (11), the resulting plaster boards (12) are provided with longitudinal tapers (13) but are not provided with transverse tapers (14).

The method according to the invention allows precisely the continuous creation of transverse tapers (14) as well as longitudinal tapers (13) on the plaster boards (12) leaving the shears (11).

According to the method of the invention, the first stage consists of creating an extra thickness below the facing paper (3) before the latter passes below the mixer (1) and before it crosses the former (7). To create this extra thickness of approximately 1.5 mm below the facing paper (3), the said facing paper (3) will be stamped along the lines of protuberances (20).

According to the invention, these lines of protuberances (20) are straight lines of a length less than the width of the facing paper (3) centered and perpendicular to the direction of unwinding of the said facing paper (3). The protuberances (16) of these lines of protuberances (20) are spaced approximately 20 mm apart and project approximately 1.5 mm below the facing paper (3), this value of 1.5 mm corresponding to the generally sought value of the transverse taper height “b” (29).

These lines of protuberances (20) are provided below the facing paper (3) on-the-fly, at a rate that can be less than two seconds and conform to a precise step “p” (48). This step “p” (48) depends on the sought length of the plaster board (12), the longitudinal expansion of the composite strip (10) during its hardening on the hardening belts (8) and (9) and the excess length necessary for the sawing of the plaster boards (12) on leaving the line. This is an interval or step “p” (48) that a person skilled in the art can easily calculate.

According to the method of the invention, these lines, discontinuous by definition, of protuberances (20) have the very unusual advantage that they do not disappear or fade under the mechanical tension “T” (47) of the facing paper (3) unlike other devised methods which consist of folding or embossing the facing paper (3) along a continuous profile and over a large width.

The method of the invention, simultaneously with the embossing of the lines of protuberances (20), notches the facing paper (3) along two lines of reinforcement notches (23). These lines of reinforcement notches (23) are realized on the outside of the facing paper (3) on either side of each line of protuberances (20) of the same length as the lines of protuberances (20) parallel and centered to the lines of protuberances (20). The function of these two lines of reinforcement notches is to reinforce, helping the line of protuberances (20) to support the weight of the hydraulic binder (2) in subsequent stages of the method.

According to a variant of the method of the invention, the length “l” (49) of the lines of protuberances (20) is equal to the width around all of the plaster board (12) minus the sum of the widths of the two longitudinal tapers (13).

The method according to the invention then consists, in the zone between the forming table (5) and the former (7), of protecting the lines of protuberances (20) against pulling out, catching or deformation. For this, in the said zone all the rough sections, all the catch points (17) are removed, and grooves are arranged on the spreader (6). Thus equipped with grooves, the said, generally vibrating or rotating, spreader (6) shakes the facing paper (3) and the hydraulic binder (2) without affecting the protuberances which pass without contact in the recess of its grooves, i.e. without contact with said spreader (6).

According to the method of the invention, as the lines of protuberances (20) cross the former (7) they raise the facing paper (3) locally and reduce accordingly the quantity of hydraulic binder (2) contained in the composite strip (10), thus the upper surface of the composite strip (10) leaving the former (7) will be uniformly flat despite the locally raised sections of the latter.

According to the method of the invention, the lines of protuberances (20) projecting below the facing paper (3) keep the composite strip (10) raised until it is completely hardened.

According to the method of the invention, on leaving the hardening belt (9) the composite strip (10) has on its lower surface double-slope imprints (19) spaced apart at a distance slightly greater than the length of the plaster boards (12) to be produced.

The method according to the invention consists in the last phase of cutting the composite strip (10) using the shears (11) at the level, in the center and in the axis of each of the double-slope imprints (19).

The result, at this stage of the method according to the invention, is a plaster board (12) with 4 tapered edges at its periphery, two traditional longitudinal tapers (13) and two transverse tapers (14) created by the method according to the invention. This plaster board (12) then crosses the drier and is sawn to length, this sawing causing the residual 1/2 lines of protuberances (50) to disappear completely. The plaster boards (12) provided with tapers over the whole of their periphery are stacked and then rejoin the factory stock.

According to a variant of the method of the invention, the cutting with the shears (11) occurs simultaneously in the double-slope imprints (19) and at an equal distance from two double-slope imprints (19), the plaster boards (12) thus produced having 3 tapers, two longitudinal tapers (13) and one transverse taper (14), these plates with 3 tapers being useful for particular market applications.

According to a variant of the method of the invention, the inside surface of the protuberances (16), the inside of the bottoms of the protuberances (22), as well as the upper and horizontal surfaces of the facing paper (3) situated between the protuberances (16) and the reinforcement notches (23), also called reinforced surface (21), are covered with a coating (15). This on-the-fly application of the coating (15) is realized immediately after the embossing operation of the lines of protuberances (20). The chemical composition of this coating (15) is such that with almost immediate effect it allows the mechanical strength of the protuberances (16) to be increased, the lines of protuberances (20) to be made impermeable and protected against softening, said lines of protuberances (20) to be made tight vis-à-vis the hydraulic binder (2), and finally a good bonding of the hydraulic binder (2) and the facing paper (3) on the reinforced surface (21) to be guaranteed.

According to another variant of the method of the invention and in order to achieve a good geometric connection of the transverse tapers (14) and the longitudinal tapers (13) on the plaster board (12), the lines of protuberances (20) are extended at each end over a length equal to the width of the longitudinal tapers (13). This extension of the line of protuberances (28) consists of protuberances (16) the depth of which decreases as the said extension of the line of protuberances (28) approaches the outside edge of the facing paper (3). This extension of the line of protuberances (28), when crossing the hardening belts (8) and (9), comes to rest on the tapered strips which serve to make up the longitudinal tapers (13).

According to a variant of the method of the invention the shape of the protuberances (16) created by embossing is adapted so that the latter have the best possible mechanical characteristics, and can equally well be of hemispherical, pyramidal, conical or half-moon shape without being limited to these.

According to a variant of the method of the invention, the facing paper (3) is marked at the start of its transverse taper (14) with a light notching, this line marking the start of the transverse taper (14) improving both the geometry and the attractiveness of the transverse taper (14). This line marking the start of the transverse taper (24) is the same length as and parallel to the line of protuberances (20) and is naturally situated vis-à-vis the latter at a distance equal to the width of the transverse taper “a” (27). This line marking the start of the transverse taper (24) through a light notching of the facing paper (3) either outside or inside the latter is realized simultaneously with the embossing of the lines of protuberances (20).

According to a variant of the method of the invention, the facing paper (3) is marked on the line connecting the transverse taper (14) and the longitudinal taper (13). This tapers connection line (26) links the end of the line marking the start of the transverse notch (14) to the end of the line of reinforcement notches (23). This tapers connection line (26) naturally forms an angle “c” (46) of 45° to the main axes of the transverse tapers (14) and longitudinal tapers (13). This tapers connection line (26) improves both the geometry and the attractiveness of the zone where the transverse taper (14) and the longitudinal taper (13) meet. This tapers connection line (26) which involves a light notching of the facing paper (3) either outside or inside the latter is realized simultaneously with the embossing of the lines of protuberances (20).

According to a variant of the method of the invention, the outside surface of the facing paper (3) corresponding to the future transverse taper (14) is roughened in order to promote the bonding of the jointing coating which will be applied later in this zone when using the plaster board (12). This rough surface (25) corresponding to polygons defined by the line of reinforcement notches (23), the line marking the start of the transverse taper (24) and the two tapers connection lines is obtained by pricking, knurling, embossing or chafing said surface. This stage of the method according to the invention of realizing the rough surfaces (25) occurs at the same time as the embossing of the lines of protuberances (20).

According to the method of the invention, the transverse taper height “b” (29) and transverse taper width “a” (27) are regulated by adjusting the following parameters:

the protuberances height “h” (45) by adjusting the depth of the embossing of said protuberances,

the steepness of the reinforcement notch (23) by adjusting the greater or lesser depth of said notch,

the steepness of the line marking the start of the transverse notch (24) by adjusting the greater or lesser depth of the notch leading to this marking of the start of the transverse taper (24),

the mechanical tension “T” (47) of the facing paper (3) by tightening the latter to a greater or lesser extent with the help of dedicated tighteners.

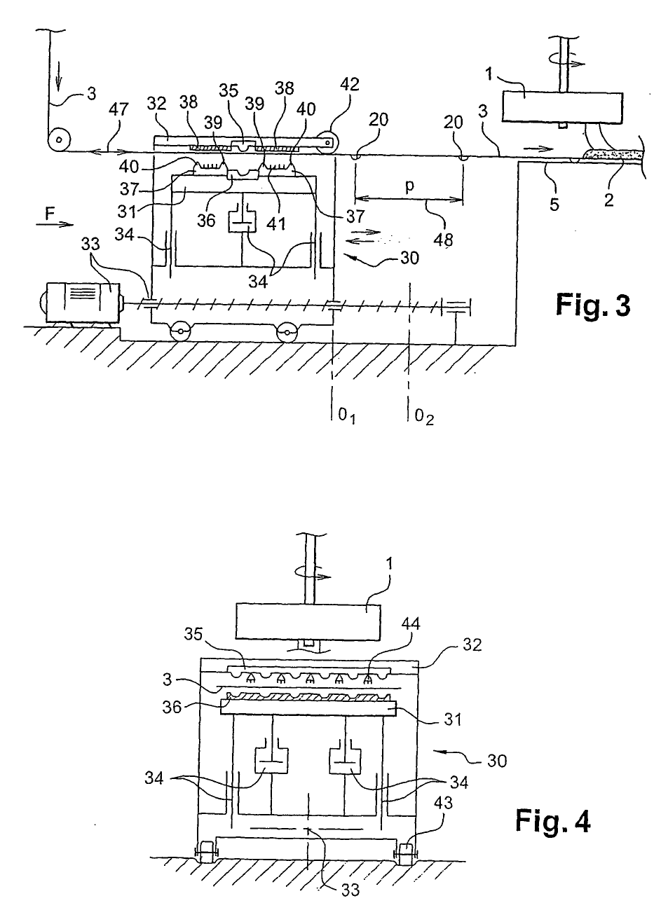

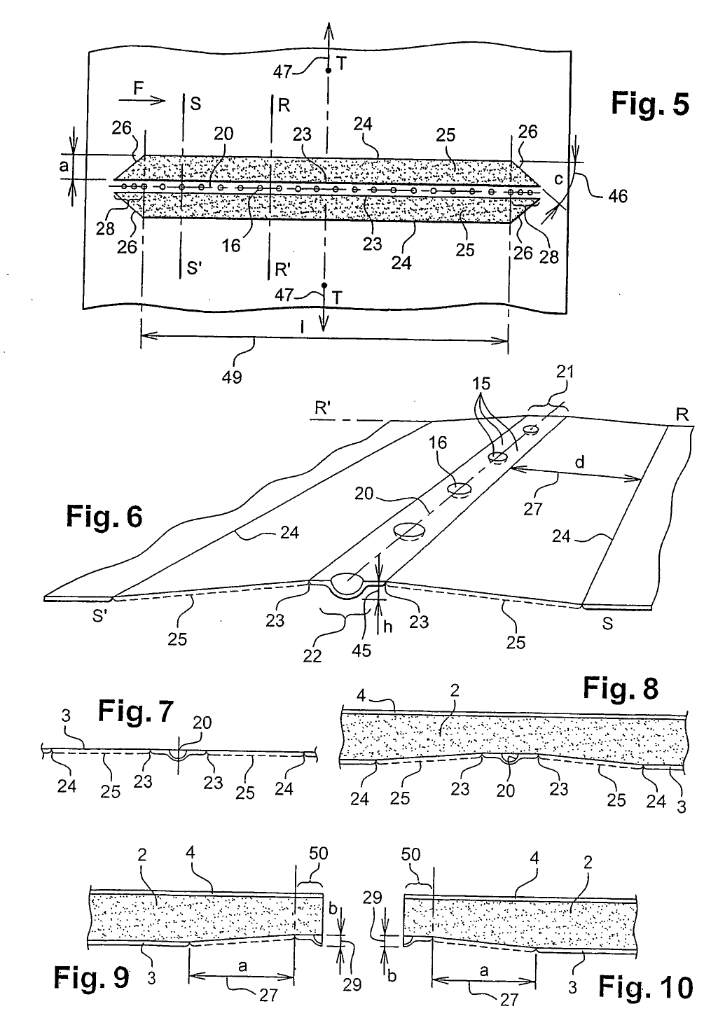

The first device, called a embossing tracker (30), associated with the method according to the invention appearing in FIG. 1 and detailed in FIG. 3 and FIG. 4 carries out all the phases of the method according to the invention of berthing and on-the-fly machining on-the-fly of the facing paper (3) before the latter engages below the mixer (1). These said machining operations are the embossing of the lines of protuberances (20), the embossing of the extensions of line of protuberances (28), the coating covering the protuberances (16), the coating covering the reinforced surface (21), the realization of the reinforcement notches (23), the notching of the lines marking the start of the transverse taper (24), the notching of the tapers connection lines (26), and the realization of the rough surface (25).

According to the invention, the embossing tracker (30) driven by its motor and transmission system (33) catches up and spends a few fractions of seconds at the same speed as the facing paper (3). Once the embossing tracker (30) is at the same speed as the facing paper (3) the lower table (31), an integral part of the embossing tracker (30), makes an up and down movement by means of the jacks and guides (34). During its up and down movement the lower table (31) compresses the facing paper against the upper table (32), also an integral part of the embossing tracker (30). During this compression of the facing paper (3) the tools fitted on the lower table (31) and the upper table (32) exert their effect and therefore locally machine the facing paper (3). Thus the punches (35) fitted to the upper table (32) and the dies (36) fitted to the lower table (31) realize the lines of protuberances (20) and according to a variant of the method according to the invention the extensions of lines of protuberances (28). Thus the stampers (37) fitted to the lower table (31) and the counter-stampers (38) fitted to the upper table (32) realize the reinforcement notches (23), the lines marking the start of the transverse taper (24), the tapers connection lines (26), the pricking of the rough surface (25). More specifically the inner ridge (39) of the stamper (37) produces the reinforcement notch, the outer ridge (40) of the stamper (37) produces the lines marking the start of the taper and the tapers connection lines (26), the needles (41) of the stamper producing the rough surfaces (25).

Immediately after the embossing and cream-paper marking (3) operations, the nozzles (44) situated between the punches (35) spray onto the protuberances (16) and onto the reinforced surface (21) the coating (15) the main function of which is to hold and reinforce the protuberances (16).

According to the invention, the embossing tracker (30) in position “02” during the machining of the facing paper (3) rapidly travels back to position “01”, a new cycle of berthing and machining the facing paper (3) resumes at a step “p” (48) of the previous machining of the facing paper (3) and thus the cycle then repeats itself.

The motor and transmission system (33) is associated with suitable electronics, and with the pulse generator (42) which permanently measures the unrolling of the facing paper (3). This motor and transmission system (33) can thus berth the facing paper at a rapid frequency (3) and allow at every step “p” (48) the machining operations necessary for the method according to the invention.

The calculation of this interval “p” peculiar to the method according to the invention is presented in the disclosure of the method according to the invention.

According to a variant of the embossing tracker (30), the punches (35) and the dies (36) allow by their shapes and counter-shapes, protuberances (16) to be realized which are either hemispherical or pyramidal or conical or even half-moon, shaped without these forms being limitative.

According to the method of the invention the protuberances (16) are protected during their passages in the zone between the forming table (5) and the former (7). For this, in the said zone all the rough sections of the forming table (5), all the catch points (17) of the guides and forming rules are removed. Grooves are provided on the spreader (6), this spreader (6) is generally a vibrating table or beating rollers beat the facing paper (3) in order to spread the hydraulic binder (2) without affecting the protuberances (16) which, passing them in the grooves, pass without being touched by the spreader (6). Thus the said zone between the forming table (5) and the former (7) does not affect the lines of protuberances (20).

The second device realizing the cut at the level of the imprints (19) is constituted by the imprint detector (18) at a distance “d” from the shears (2) and suitable electronics which, knowing the speed “V” of the composite strip (45), orders the shears (11) to cut the composite strip (10) into sections at the level of the double-slope imprint (19).

1-10. (canceled)

11. A method of continuous production of plaster boards in which two sheets of cardboard-type paper, one constituting facing paper and the other gray or backing paper, enclose in a former a plaster-based hydraulic binder creating a composite strip which hardens on two hardening belts and around the edge of which are two tapered strips for the making-up of the longitudinal tapered edges, the method comprising:
embossing the facing paper along lines of protuberances transverse and perpendicular to a direction of unwinding of the facing paper and projecting below said facing paper, said lines of protuberances being produced:
over a length equal to the width of the plaster board minus the sum of the widths of the two longitudinal tapers,
in a zone situated before the mixer and former,
at a high rate, on-the-fly, and with a distance between the lines of protuberances corresponding to the future length of the plaster board,
notching the facing paper, simultaneously with the notching of the lines of protuberances, along two continuous straight lines of reinforcing notches, said lines of reinforcement notches being realized:
on the outside of the facing paper,
on either side of each line of protuberances,
with the same length as the lines of protuberances,
parallel to and centered vis-ac-vis the lines of protuberances,
protecting the lines of protuberances against pulling out, catching or deformation until the crossing of the former,
allowing said lines of protuberances projecting below the facing paper to cross the former, and to locally reduce the quantity of hydraulic binder enclosed between the facing paper and the gray or backing paper,
allowing said lines of protuberances projecting below the facing paper to rest on the two hardening belts,
and, locally raising said facing paper and generating double-slope imprints,
allowing the double-slope imprints to cross the two hardening belts and,
cutting the composite strip using the shears at the level, in the center and in the axis of each of the double-slope imprints thus created.

12. The method according to claim 11, wherein all the insides of the protuberances and the upper and horizontal surfaces of the facing paper between the protuberances and the reinforcing notches, said surface being called reinforced surface, are covered by a layer of coating, on-the-fly applications of said coating being realized immediately after the embossing operation of the lines of protuberances, the coating comprising:
increasing the mechanical strength of the lines of protuberances,
making the lines of protuberances impermeable,
making the lines of protuberances tight vis-à-vis the hydraulic binder,
guaranteeing a good bonding of the hydraulic binder and the facing paper at the reinforced surface.

13. The method according to claim 11, wherein the lines of protuberances are extended at each of their ends over a length equal to the width of the longitudinal tapers by an extension of the line of protuberances with protuberances the protuberance height of which decreases as said line of protuberances approaches the outside edge of the facing paper, said extension of the line of protuberances during the crossing of the hardening belts and coming to rest on the tapered strips, the function of said tapered strips being the making-up of the longitudinal tapers.

14. The method according to claim 12, wherein the lines of protuberances are extended at each of their ends over a length equal to the width of the longitudinal tapers by an extension of the line of protuberances with protuberances the protuberance height of which decreases as said line of protuberances approaches the outside edge of the facing paper, said extension of the line of protuberances during the crossing of the hardening belts and coming to rest on the tapered strips, the function of said tapered strips being the making-up of the longitudinal tapers.

15. The method according to claim 11, wherein the facing paper is premarked by a taper start marking line, corresponding to a future start of the transverse taper, said taper start line being the same length as and parallel to the line of protuberances and at a distance from the latter, said distance being equal to the sought width “a” of the transverse taper, this premarking involving a light notching of the facing paper and occurring at the same time as the embossing of the lines of protuberances.

16. The method according to claim 15, wherein the facing paper is premarked by a tapers connection line corresponding to the meeting of the longitudinal taper and the transverse taper, said tapers connection line starting from the end of the line marking the start of the transverse taper and ending at the line of reinforcing notches at an angle of 45°, said premarking involving a light notching of the facing paper and occurring at the same time as the embossing of the lines of protuberances.

17. The method according to claim 11, wherein the outside surface of the facing paper corresponding to the future transverse taper and situated in the polygon defined by the line of the reinforcing notch, the line marking the start of the transverse taper and the two tapers connection lines is roughened by pricking, knurling, embossing or by chafing, this stage of the method according to the invention of realizing the rough surface occurring at the same time as the embossing of the lines of protuberances.

18. The method according to claim 11, wherein the height of the transverse taper and the width of the transverse taper are regulated by adjusting the following parameters:
the protuberances height,
the steepness of the reinforcing notch,
the steepness of the line marking the start of the transverse taper, and
the mechanical tension of the facing paper.

19. An apparatus for implementing a method of continuous production of plaster boards in which two sheets of cardboard-type paper, one constituting facing paper and the other gray or backing paper, enclose in a former a plaster-based hydraulic binder creating a composite strip which hardens on two hardening belts and around the edge of which are two tapered strips for the making-up of the longitudinal tapered edges, comprising:
embossing the facing paper along lines of protuberances transverse and perpendicular to the direction of unwinding of the facing paper and projecting below said facing paper, said lines of protuberances being produced over a length equal to the width of the plaster board minus the sum of the widths of the two longitudinal tapers, in a zone situated before the mixer and former, at a high rate, on-the-fly, and respecting a distance between the lines of protuberances corresponding to a future length of the plaster board,
notching the facing paper, simultaneously with the notching of the lines of protuberances, along two continuous straight lines of reinforcing notches, said lines of reinforcement notches being realized on the outside of the facing paper, on either side of each line of protuberances, with the same length as the lines of protuberances, parallel to and centered vis-à-vis the lines of protuberances, protecting the lines of protuberances against pulling out, catching or deformation until the crossing of the former,
allowing said lines of protuberances projecting below the facing paper to cross the former, and to locally reduce the quantity of hydraulic binder enclosed between the facing paper and the gray or backing paper,
allowing said lines of protuberances projecting below the facing paper to rest on the two hardening belts,
and, locally raising said facing paper and generating the double-slope imprint,
allowing the double-slope imprints to cross the two hardening belts and,
cutting the composite strip using the shears at the level, in the center and in the axis of each of the double-slope imprints thus created,
said apparatus comprising:
a production line for plaster boards in which two sheets of cardboard-type paper, one constituting facing paper and the other gray or backing paper unwind and enclose in a former a plaster-based hydraulic binder and constitute a composite strip which hardens on two hardening belts fitted with tapered strips for the making-up of longitudinal tapers,
an embossing tracker situated in a zone just before the mixer the functions of which are: berthing on-the-fly the facing paper at the distance, embossing said facing paper to produce lines of protuberances, notching said facing paper to produce lines of reinforcing notches, embossing said facing paper to produce the extensions of the line of protuberances, notching said facing paper to produce lines marking the start of the transverse taper and tapers connection lines, roughening the rough surface corresponding to the future transverse taper, and
a shearing apparatus situated after the hardening belts and the function of which is to cut the composite strip at the level, in the center and in the axis of the double-slope imprints.

20. The apparatus according to claim 19, wherein the embossing tracker is constituted by a lower table situated below the facing paper and an upper counter-table situated above the facing paper, said lower table being fitted with jacks and guides, dies, stampers, each of said stampers having an inner ridge and an outer ridge and needles, said upper table being fitted with punches, a counter-stamper, nozzles for coating and a pulse generator, both of the two said lower and upper tables being an integral part of the embossing tracker, itself driven by the motor and transmission system.

21. The apparatus according to claim 19, wherein the shearing apparatus is constituted by shears, an imprint detector, said imprint detector being situated at the known distance from the shears and a shears cut calculator.
